(19) United States
(12) Patent Application Publication
(10) Pub. No.: US 2005/0125414 A1
(43) Pub. Date: Jun. 9, 2005

(54) System and method for facilitating asynchronous disconnected operations for data access over a network

(76) Inventors: Julio C. Navas, Concord, CA (US); Ying Shu, Los Altos, CA (US)

Correspondence Address: GLENN PATENT GROUP, 3475 EDISON WAY, SUITE L, MENLO PARK, CA, 94025, US

(21) Appl. No.: 10/966,777

(22) Filed: Oct. 15, 2004

Related U.S. Application Data
(60) Provisional application No. 60/512,305, filed on Oct. 16, 2003.

(51) Int. Cl. G06F 7/00

(52) U.S. Cl. 707/10

(57) ABSTRACT

A system and method for facilitating asynchronous disconnected operations for data access over a network are described. In one preferred embodiment, a query in a database language is received from a user in a network. The query is converted into a plurality of network messages, each network message containing a fragment of the query. The network messages are transmitted through a network of a plurality of dynamic query routing nodes toward a plurality of data sources that are relevant to the query. When the network message reaches a leaf router with a corresponding relevant data source, a determination is made whether each data source of a plurality of disparate data sources is either in a connected or disconnected state, each data source storing data related to the query fragment within each network message. The query is further stored for a predetermined period of time at the leaf router until each data source has entered a connected state to the corresponding router within the network or until the specified lifetime limit for the query. Upon the data source entering a connected state, the leaf router will forward the query fragment network message to that particular data source. The data source will then process the query for the specified times and return the results to the user. If the data source returns again to a disconnected state, then the data source will store the query and any query result sets until it returns to a connected state or until the specified lifetime limit for the query.

### CROSS-REFERENCE TO RELATED APPLICATIONS

This patent application claims priority from U.S. Provisional Patent Application Ser. No. 60/512,305, filed on Oct. 16, 2003, and entitled “Asynchronous Disconnected Operations For Data Access Through A Content Routing Network,” which is incorporated by reference herein in its entirety. This patent application is also related to U.S. patent application Ser. No. 09/728,380, filed on Nov. 28, 2000, and entitled “Characteristic Routing”, U.S. patent application Ser. No. 09/726,702, filed on Nov. 28, 2000, and entitled “System and Methods For Highly Distributed Wide-Area Data Management Of A Network Of Data Sources Through A Database Interface”, U.S. patent application Ser. No. 10/096,154, filed on Mar. 11, 2002, and entitled “Characteristic Routing”, and U.S. patent application Ser. No. 10/096,209, filed on Mar. 11, 2002, and entitled “System and Methods For Highly Distributed Wide-Area Data Management Of A Network Of Data Sources Through A Database Interface”, all of which are incorporated by reference herein in their entirety.

### TECHNICAL FIELD

The invention relates generally to the field of multi-source data integration, distributed data management, and network communications and, more particularly, to a system and method for facilitating asynchronous disconnected operations for data access over a network, such as, for example, a content routing network.

### BACKGROUND OF THE INVENTION

The present invention relates to query operations on data sources that may or may not be disconnected. In the present invention, the query or a query fragment is transported to the originating scattered sources of information instead of the data being stored in one or more central databases.

The current attempts described below assume that all disparate data sources are already collected into a one or more central database master servers. Typically, the assumptions fall into these categories:
1. The client is mobile and possibly disconnected but the database servers themselves are always connected
2. A collection of multiple replicated master databases are kept synchronized even in the face of occasional disconnection
3. Mobile and disconnected clients will enact transactions on stored subsets of the master databases and their transactions are incorporated in some manner into the master databases.

4. Streams of data flow to the mobile clients who then execute query operations on the streams to discover useful nuggets of information.

However, in a environment of disconnected sources of original data, the sources of information do not always have an available Internet Protocol (IP) connection, or restrictions exist during permitted communications. Thus, what is needed is a system and method to enable execution of queries and processing of query results in such a environment of disconnected data sources until connections are restored and the results can be delivered to the respective parties.

I. Mobile Client Views

These papers relate to our invention on the aspect that clients are the ones initiate connections and updates. In our system, data sources are the ones that initiate cached queries to execute them. Their systems cache frequently queried data while our system caches queries. Instead of concerning data changes in the server database in their system, our system concerns changes of queries from Query Processor and data changes in data sources.

A. Data Warehousing Alternatives for Mobile Environments

Data warehousing alternatives [DW_Alt] focuses on incremental view updates in a mobile data warehouse environment. Like CB, it uses a true SQL model and not a keyword search model. Its main concept is to maintain a reduced view of the data warehouse in the form of a locally cached portion (or view) of the data warehouse on the mobile device.

B. Digital Library Services in Mobile Computing

Digital Library services [DigLib] handles the case of mobile and possibly disconnected users querying static data sources. It proposes a simplified query interface that is more akin to search engine key-word-search than to database SQL. However, they do include the concept of lifetime of a query. Results are at the file-level and not the individual data item level.

C. Incremental View Update for a Mobile Data Warehouse

Lee, et al's “Incremental view update for a mobile data warehouse” [IncrView] addresses the view update problem for maintaining a mobile data warehouse. It proposes a “pull-based” approach that allows a materialized view to be updated at clients incrementally. When a mobile warehouse decides to update its view at certain time t, it sends its view definition together with t. The server then determines the insertion set and deletion set of the base relations in the database which the view is derived since t time and transmits them to client. Frequently queried data is cached in client as warehouse.

D. System and Method for Efficient Cache Management in a Distributed File System

The patent (U.S. Pat. No. 6,119,151) “System and method for efficient cache management in a distributed file system” [U.S. Pat. No. 6,119,151] focuses on a cache manager efficiently supporting both connected and disconnected client operations. Whenever a client file system needs an object from the distributed file system, it will first search its cache, and transform the requests to remove operating system dependent syntax. If the object exists already, it will just use it.

The invention is in the area of file system and mostly relates to operation system operations. Both their system and our system support WAN/LAN and multiple users. Clients always initiate requests. Even though the cache mechanism is similar in our system to theirs, our system is in different context and application areas—distributed database query processing. We cache queries to reuse them. Our operations are bidirectional. QP sends new queries to data sources and data sources rescan themselves and update bit vectors to their designated DQRs when there is data change.

II. Replication and Synchronization

These inventions describe the expensive synchronization of master database servers that may or may not be disconnected. These servers already assume that the information from the originating sources has been collected and transformed into a single database image. The present invention instead sends the query to the originating sources because limitations in the network connections of these sources prevents the full synchronization of the data.

A. Distributed Disconnected Databases

Distributed Disconnected Databases [DiscDB] addresses database replication and synchronization. It uses reference files that effectively double the storage requirements per table.

B. The Evolution of Coda

CODA [CODA] handles disconnected operations at a file-system level. It employs a small number of trusted and connected servers that are custodians of the master copies of the files. CODA aims separate the namespace from the actual location of the files and make this transparent to the user. It operates and caches whole files only. It employs a callback-based cache coherence algorithm in order to maintain up-to-date replication. The unit of replication is a volume or collection of files.

C. Position Papers: Bayou: Replicated Database Services for World-Wide Applications

Bayou [Bayou] addresses the full database replication problem. It doe not require global consensus among the servers, though. It offers and employs a weakly consistent replicated database model. Writes are propagated by a pair-wise anti-entropy protocol that permits incremental updates.

D. The Dangers of Replication and a Solution

Dangers of Replication [Danger] addresses the problems associated with full database replication. It proposes a two-tier approach to reconciliation.

E. Disconnection Modes for Mobile Databases

Disconnection Modes [DisMobDB] focuses on replicated databases and shared data synchronization. In particular, it focuses on techniques for planned or voluntary disconnection.

F. Directory Cache Management in a Distributed Data Processing System

The patent (U.S. Pat. No. 5,151,989) “Directory cache management in a distributed data processing system” [U.S. Pat. No. 5,151,989] describes an improved directory caching technique that when a local data processing system interrogates a remote server data processing system for a unit of directory information, the server system is enabled to automatically send additional units of pertinent director information back to the client system in response to a subsequent change in the directory structure of the server system.

G. Transaction Synchronization in a Disconnected Computer and Network

The patent (U.S. Pat. No. 5,991,771) “Transaction synchronization in a disconnected computer and network” [U.S. Pat. No. 5,991,771] presents a method for transaction synchronization which occurs after the computers are reconnected, transfers information from each computer to the other computer and applies updates to both replicas as appropriate.

III. Integrating Mobile Transactions

These inventions assume that a mobile user is enacting transactions against a local subset of the master database. These transactions are then reintegrated when the client reconnects to the network. However, we assume in the present invention just the opposite situation where the data sources are disconnected and not the client.

A. Escrow Techniques for Mobile Sales and Inventory Applications

Escrow [Escrow] techniques proposes replicating distributed database servers. It would partition geographic areas into service areas. Only the client is assumed to be mobile and/or disconnected. The technique employs local caches, called “escrows,” to store a subset of the database, dynamic resource reconfiguration to upload changes from the mobile to the service area database, and simplified 2-phase commit protocols in order to synchronize data between the distributed database servers.

B. Zippering: Managing Intermittent Connectivity in DIANA

Zippering [Zipper] Addresses the Client-Server Model and Only Addresses User connectivity and not data connectivity. It deals with integrating operations upon reconnection.

IV. Streamed Data Processing

This system mostly relates to us on caching queries and supports disconnected operations. However, our system does not pre-compute results since our data sources have the most updated data. The new data is propagated upstream through content-based rescan.

A. PSoup: A System for Streaming Queries Over Streaming Data

“PSoup: a system for streaming queries over streaming data” [PSoup] describes an architecture that both data and queries are streaming. Multi-query processing is viewed as a join of query and data streams. Every time a new query comes, it is cached in a structure. The query is then applied to all the data to find qualified results. When a new data entered into the system, it is saved to a data storage structure. The data is then probed to all the queries to see whether it qualifies any of them. Therefore their system supports both executing queries over historical data and executing continuous queries. PSoup also partially pre-computes and materializes results to support disconnected operation and to improve data throughput and query response times.

### SUMMARY OF THE INVENTION

A system and method for facilitating asynchronous disconnected operations for data access over a network are described. In one preferred embodiment, a query in a database language is received from a user in a network. The query is converted into a plurality of network messages, each network message containing a fragment of the query. The network messages are transmitted through a network of a plurality of dynamic query routing nodes toward a plurality of data sources that are relevant to the query. When the network message reaches a leaf router with a corresponding relevant data source, a determination is made whether each data source of a plurality of disparate data sources is either in a connected or disconnected state, each data source storing data related to the query fragment within each network message. The query is further stored for a predetermined period of time at the leaf router until each data source has entered a connected state to the corresponding router within the network or until the specified lifetime limit for the query. Upon the data source entering a connected state, the leaf router will forward the query fragment network message to that particular data source. The data source will then process the query for the specified times and return the results to the user. If the data source returns again to a disconnected state, then the data source will store the query and any query result sets until it returns to a connected state or until the specified lifetime limit for the query.

### BRIEF DESCRIPTION OF THE DRAWINGS

FIG. 1 is a block diagram illustrating an exemplary network-based distributed data management system;

FIG. 2 is a block diagram illustrating a network-based system for facilitating asynchronous disconnected operations for data access over a network, according to one embodiment of the invention;

FIG. 3 is a flow diagram illustrating a method for facilitating asynchronous disconnected operations for data access over a network from the perspective of a data source manager within the system, according to one embodiment of the invention;

FIG. 4 is a flow diagram illustrating a method for facilitating asynchronous disconnected operations for data access over a network from the perspective of a dynamic query router within the system, according to one embodiment of the invention;

FIG. 5 is a flow diagram illustrating a method for facilitating asynchronous disconnected operations for data access over a network from the perspective of a query processor within the system, according to one embodiment of the invention;

FIG. 6 is a diagrammatic representation of a machine in the exemplary form of a computer system within which a set of instructions may be executed.

### DETAILED DESCRIPTION

I. Exemplary network-based distributed data management system 9
II. Facilitating asynchronous disconnected operations for data access 11
III. Data Source Manager Perspective 15
   A. Transferring Index Information 15
   B. Handling Query Fragments 15
   C. Handling Result Sets 17
   D. Exemplary DSM operations 17
IV. Dynamic Query Router Perspective 22
V. Query Processor Perspective 24
VI. Exemplary form of a computer system 25

I. Exemplary Network-Based Distributed Data Management System

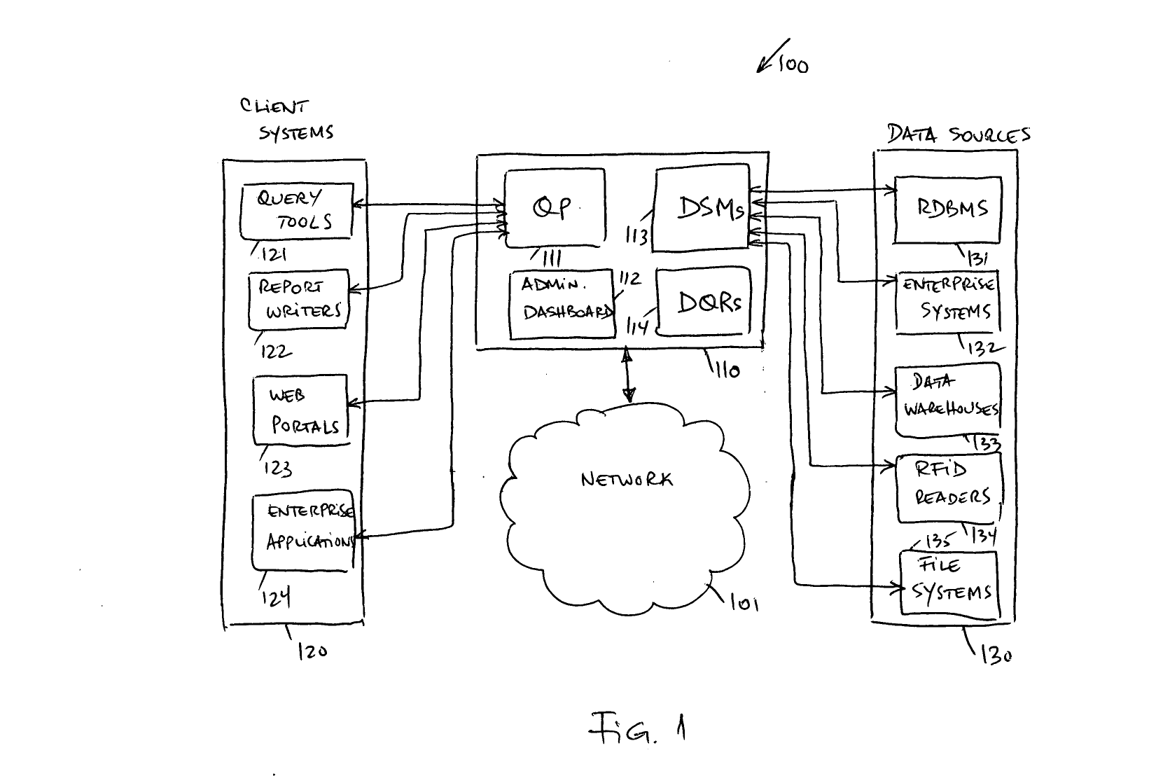

FIG. 1 is a block diagram illustrating an exemplary network-based distributed data management system. As illustrated in FIG. 1, in one embodiment, the system 100 includes a data management entity 110 coupled to a network 101, such as, for example, a wide-area network (WAN). Wide-area network 101 includes the Internet, specifically the World Wide Web (Web), or other proprietary networks, each of which are well known to those of ordinary skill in the art. Wide-area network 101 may also include conventional network backbones, long-haul telephone lines, Internet service providers, various levels of network routers, and other conventional means for routing data between computers. In an alternate embodiment, the network 101 is a local area network (LAN) or any other known networks.

Using conventional network protocols, the entity 110 communicates through the wide-area network 101 with a plurality of client systems 120. In one embodiment, the client systems 120 include, but are not limited to, query tools 121, report writers 122, web portals 123, and enterprise applications 124. Users access the client systems 120 and communicate with the entity 110 and the data source managers 113 via the network 101.

The entity 110 is connected through the network 101 to a plurality of distributed, heterogeneous data sources 130 and communicates with the data sources 130 using database protocols, application protocols, messaging protocols, or similar conventional network protocols. In one embodiment, the data sources 130 include, but are not limited to, relational database modules (RDBMS) 131, enterprise systems 132, data warehouses 133, radio frequency identification (RFID) readers 134, and/or file systems 135. Alternatively, the entity 110 may be connected to any of a variety of additional data sources.

In one embodiment, the entity 110 includes a query processor (QP) 111 coupled to each client system 121-124. The query processor 111 is a module for providing a consolidated query entry and exit point for the entity 110 and for providing multiple functions to the system 100, such as, for example, standard interfaces to support the front-end applications and tools 120, a single system view of the disparate data sources 130, and query optimization.

Furthermore, the entity 110 includes multiple data source managers (DSM) 113, each DSM 113 being coupled to a data source 131-135 and being a module for providing data access to the variety of data sources 130. In addition, the entity 110 includes multiple dynamic query routers (DQR) 114, which form an overlayed network of information detailing specific locations of item-level data that runs on top of the network 101 within the system 100. Each DQR 114 is a module for creating dynamic data flow paths that route queries only to corresponding data sources 131-135 that have information concerning particular query items.

In one embodiment, the entity 110 further includes an administration dashboard 112, which provides an easy-to-use, web-based interface module for managing the entire network of DQRs 114, all QPs 111, and all DSMs 113 and for facilitating access to various administration tasks necessary to keep the system 100 performing optimally.

The system 100 and its components have been described in great detail in connection with related U.S. patent application Ser. No. 09/728,380, filed on Nov. 28, 2000, and entitled “Characteristic Routing”, U.S. patent application Ser. No. 09/726,702, filed on Nov. 28, 2000, and entitled “System and Methods For Highly Distributed Wide-Area Data Management Of A Network Of Data Sources Through A Database Interface”, U.S. patent application Ser. No. 10/096,154, filed on Mar. 11, 2002, and entitled “Characteristic Routing”, and U.S. patent application Ser. No. 10/096,209, filed on Mar. 11, 2002, and entitled “System and Methods For Highly Distributed Wide-Area Data Management Of A Network Of Data Sources Through A Database Interface”, all of which are incorporated by reference herein in their entirety.

II. Facilitating Asynchronous Disconnected Operations for Data Access

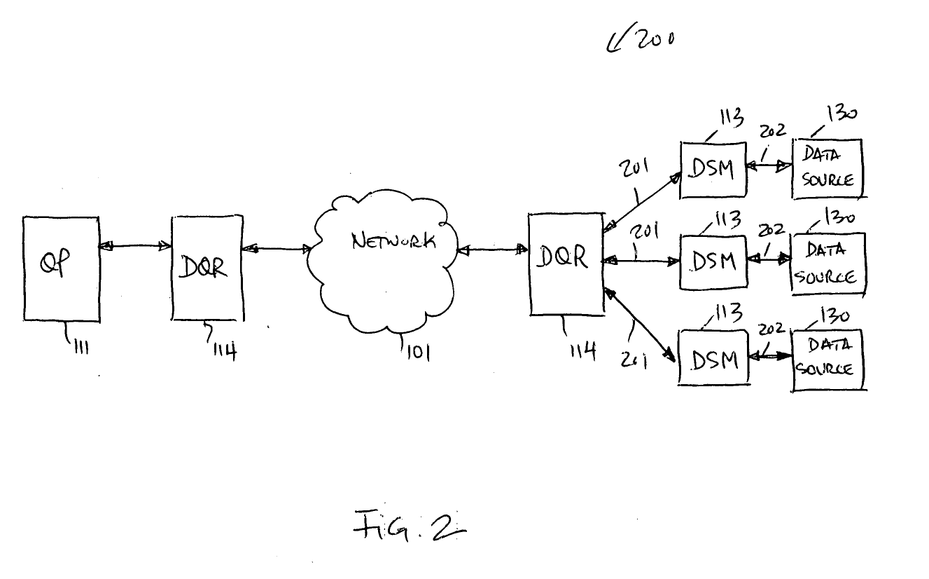

FIG. 2 is a block diagram illustrating a network-based system 200 for facilitating asynchronous disconnected operations for data access over a network, according to one embodiment of the invention. As illustrated in FIG. 2, a query processor (QP) 111 is coupled to an originating dynamic query router (DQR) 114 of multiple DQRs 114 that create multiple dynamic data flow paths over the network 101, such as, for example, the Internet, and enable transmission of network messages. Each additional DQR 114 may or may not be further coupled to one or more data source managers (DSM) 113 via communication links 201, such as, for example, dial-up connections and/or wireless connections. Each DSM 113 is further coupled to one or more disparate data sources 130 via communication links 202, such as, for example, dial-up connections and/or wireless connections.

In one embodiment, the client systems 120 shown in FIG. 1 gather information from the disparate data sources 130 through queries transmitted to the system 200. The QP 111 receives the query from the client systems 120, such as, for example a Structured Query Language (SQL) query, and converts the query from its traditional database format into one or more network messages, each network message containing a query fragment of the initial query. In alternate embodiments, the query may be an Extensible Markup Language (XML) query, or an Xquery, or any other type of database language query.

The OP 111 further caches the query for a predetermined period of time. In one embodiment, each query has an operational lifetime and would be active only for the predetermined duration of its lifetime. The query will not terminate until its lifetime expires, until it is cancelled by a user, or a complete query response is produced, as described in further detail below.

In one embodiment, the client systems 120 may schedule the query to begin at a designated start time. The QP 111 is then configured to cache the query locally until the designated start time, subsequently execute the query, and get the returned results.

Subsequent to conversion of the query into network messages, in one embodiment, the QP 111 transmits the network messages to an originating DQR 114 coupled to the QP 111. In one embodiment, the originating DQR 114 and all leaf DQRs 114, which are defined to be DQRs 114 that have one or more associated DSMs 113, maintain in hard state the status of each respective connected DSM 113 and transport the messages through the network 101 directly to the specific DSMs 113 coupled to data sources 130 that have relevant data, as described in further detail below.

If one of the paths to the respective DSM 113 is not available because the corresponding communication link 201 is disconnected, the corresponding leaf DQR 114 will cache the query fragments until the connection is reestablished, as described in further detail below.

In one embodiment, the DSM 113 executes the query locally against the respective data source 130 and transmits a reply message containing query results back to the QP 111 via the corresponding DQRs 114 and the network 101. If a connection 201 to the respective DQR 114 is not available for transmission of the query results, the DSM 113 caches the query results until such connection is reestablished, as described in further detail below.

Subsequent to transmission of all reply messages, the QP 111 collects the corresponding query results and displays the results for the user.

In one embodiment, the QP 111 remains active and connected to the network 101 for the duration of the query, even though users connected to the client systems 120 may disconnect while waiting for the query results. If a particular client system 120 drops the connection to the QP 111, the QP 111 continues to execute the query and caches any query results until the client system 120 reconnects to the QP 111.

When executing the query, the QP 111 generally times out after a default time interval, such as, for example, a number of time units such as seconds. If the query has a predetermined operational lifetime, then the QP 111 times out after the expiration of the query lifetime instead of its default timeout.

In one embodiment, if the QP 111 waits until its local originating DQR 114 transmits that all possible responders have sent in a response, whether the response is null or contains some query results, then the query is terminated. In an alternate embodiment, if the specified lifetime of the query has been reached, then the query may be terminated.

In yet another alternate embodiment, a user may indicate that a query should be terminated prior to its complete execution. In this case, a “delete” signal may be sent from the QP 111 to all relevant DSMs 113 through the corresponding DQRs 114 and the network 101. This signal causes the QP 111, all of the intervening DQRs 114, and all the relevant DSMs 113, to discard the query and any results sets from their respective cache memories. In one embodiment, a modification of a query is equivalent to a termination of the query and submission of a modified new query.

In one embodiment, in the above operation of the system 200, no schema changes occur during the execution of a query. Alternatively, in real-time applications, query and schema changes must be taken into consideration. The administrative dashboard 112 shown in FIG. 1 performs all schema changes and notifies all components of the changes performed.

In one embodiment, the distribution of a new schema is delayed until pending queries are executed and terminated according to embodiments described above. Any new queries will also be delayed until the new schema is implemented and is propagated within the system 200. In an alternate embodiment, all pending queries are terminated prior to distribution of the new schema. If the schema changes do not affect the terminated queries, then they can be optionally re-executed. In yet another alternate embodiment, only the pending queries which may be affected by the new schema changes are terminated and all others continue to execute. Subsequent to the distribution of the new schema, these queries can be optionally re-executed if the schema changes do not prevent the queries from such re-execution.

III. Data Source Manager Perspective

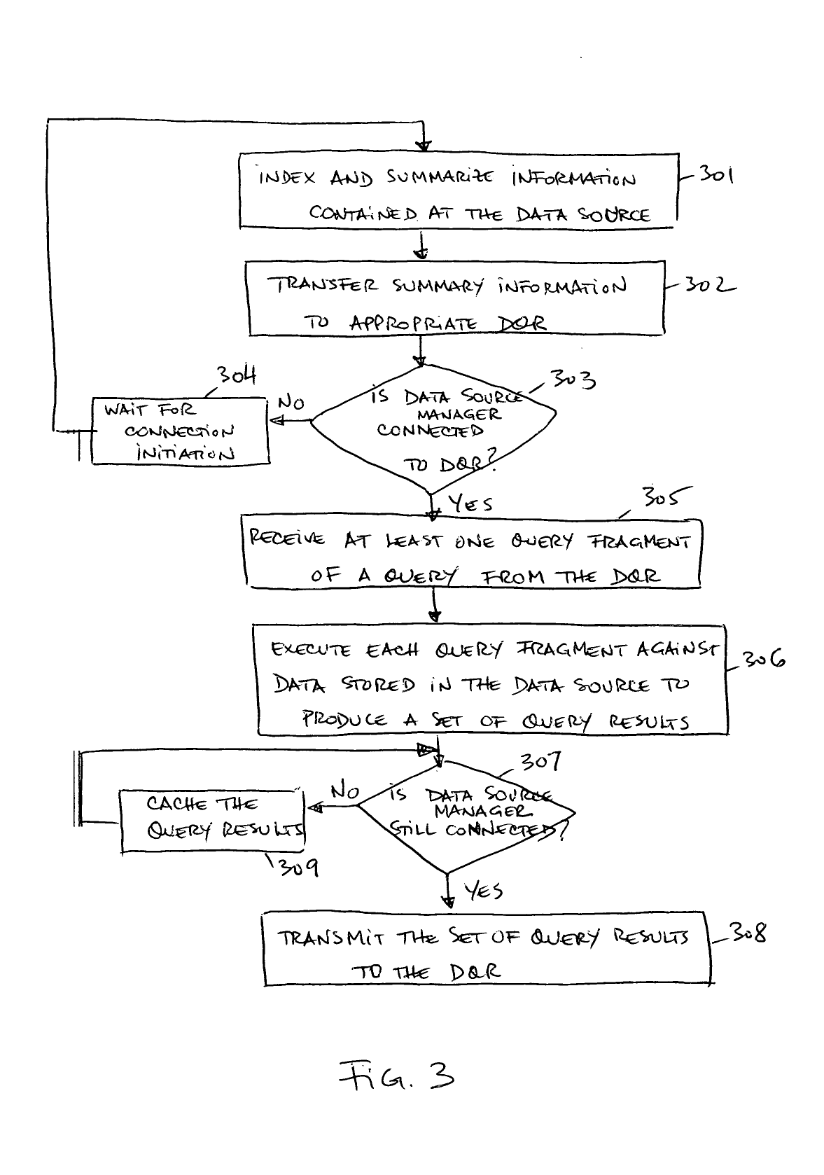

FIG. 3 is a flow diagram illustrating a method for facilitating asynchronous disconnected operations for data access over a network from the perspective of a data source manager within the system, according to one embodiment of the invention.

A. Transferring Index Information

As illustrated in FIG. 3, at processing block 301, data stored in a corresponding data source 130 is indexed and summarized. In one embodiment, during the initialization of the system 200, the DSM 113 indexes and summarizes the information contained at each corresponding data source 130 and creates a summary of information.

At processing block 302, the summary information is transferred to the corresponding DQR 114. In one embodiment, when the data source manager 113 connects to the leaf DQR 114 via the associated DSM 113 and respective communication links 201, 202, the DSM 113 transfers the summary information to the leaf DQR 114 for incorporation into a network database or routing table of the DQR 114.

At processing block 303, a decision is made whether the data source manager 113 is connected to the leaf DQR 114. In one embodiment, the data source manager 113 may be in a disconnected state for various reasons, such as, for example, due to a dial-up connection interruption, a wireless connection interruption, or other known network disruptions.

B. Handling Query Fragments

If the data source manager 113 is not connected to the DQR 114, and, thus, is in a disconnected state, then at processing block 304, the DSM 113 waits for connection initiation and the procedure repeats with processing blocks 301 through 303. Otherwise, if the data source manager 113 is connected to the leaf DQR 114, and, thus, is in a connected state, at processing block 305, at least one query fragment of the query is received from the corresponding DQR 114. In one embodiment, the D SM 113 receives the network messages containing the one or more query fragments from the DQR 114.

At processing block 306, each query fragment is executed against data stored in the data source 130 to produce a set of query results. In one embodiment, the DSM 113 translates each query fragment into the leaf data source's native query interface (not shown), which includes, for example, query languages as well as application APIs, then executes each query fragment against the data source 130, and finally retrieves query results from the associated data source 130.

In one embodiment, the DSM 113 also caches the query fragments during the operational lifetime of the query that originated the query fragments. The DSM 113 can periodically re-execute the query fragments at the data sources 130 at a user-specified predetermined interval of time. Thus, data traffic flow is reduced by allowing a recurring execution operation to take place without the need to resend the query repeatedly to the DSM 113. The DSM 113 terminates the caching of the query fragments once the query is satisfied and all qualifying query results are returned to the QP 111 via the DQRs 114 and the network 101.

In an alternate embodiment, if the user knows that some of the data source managers 113 may be disconnected, the DSM 113 may receive a network message containing a flag having a predetermined value that determines if the DSM 113 should cache the query fragments contained within the network message. In another alternate embodiment, the DSM 113 may continue to cache the query fragments until a storage capacity is reached. The DSM 113 may subsequently execute future data retrieval operations directly from its cache. A cached query fragment would be invalidated when the DSM 113 re-summarizes the data contained within the data source 130 for indexing purposes and discovers that changes in the stored data affect the set of query results for that particular query fragment.

C. Handling Result Sets

At processing block 307, a further decision is made whether the data source manager 113 is still in a connected state. In one embodiment, if the data source manager 113 is still connected to the leaf DQR 114, at processing block 308, the query results are transmitted to the DQR 114. Alternatively, if the data source manager 113 is not connected to the leaf DQR 114, at processing block 309, the query results are cached and processing block 307 is repeated. In one embodiment, the DSM 113 caches the query results until a connection is established between the data source manager 113 and the corresponding DQR 114.

D. Exemplary DSM Operations

Considering:

| Notation | Description |
|---|---|
| Q | Query Q that is issued by the user |
| d | The number of data sources 130 |
| m | The number of Data Source Managers 113 where |
| | m ≧ d |
| [t₀ . . . tₙ . . . t_{∞}] | Timeline starting at point t₀ and extending into |
| | infinity where 0 ≦ n ≦ ∞ |
| DSᵢ | Data source DSᵢ 130 where 0 ≦ i ≦ d |
| DSM_{i,j} | Data Source Manager DSM_{i,j} 113 that is attached to |
| | data source DSᵢ 130 and where 0 ≦ j ≦ m |
| r | r is the rate at which query Q that is cached at DSM_{i,j} is |
| | re-evaluated against DSᵢ |
| RS_{i,p} | Result Set RS_{i,p} returned from data |
| | source DSᵢ 130 at time tₚ where 0 ≦ p ≦ ∞ |

the following exemplary DSM 113 operations can be executed within the system 200:

| Query | Number of | Connectivity of Data Sources | |
|---|---|---|---|
| Lifetime | Responses | All Connected | Some Disconnected |
| Immediate | Single Global | Shows result set RS_{i,0} | Shows result set RS_{i,0} |
| at time t₀ | Response | from the first DSM_{i,j} to | from the first connected |
| | | respond at time t₀ | DSM_{i,j} to respond at time |
| | | Globally end query Q | t₀ |
| | | after the first response | DSM_{i,j} that are |
| | | | disconnected at time t₀ |
| | | | are ignored |
| | | | Globally end query Q |
| | | | after the first response |
| | Single | Show accumulated | Shows accumulated |
| | Response | results sets RS_{i,0} from all | result sets RS_{i,0} from the |
| | per DSM | DSM_{i,j} at time t₀ | all of the DSM_{i,j} that are |
| | | | connected at time t₀ |
| | | | Disconnected DSM_{i,j} are |
| | | | ignored |
| | Multiple | n/a | n/a |
| | Responses | | |
| | per DSM | | |
| Time | Single Global | Shows results from the | Shows results from the |
| Limited to | Response | first DSM_{i,j} to respond | first connected DSM to |
| Window | | within time window [t₀:tₙ] | respond within time |
| [t₀:tₙ] | | If DSᵢ at time t₀ would | window [t₀:tₙ] |
| | | return a null response, | If DSᵢ at time t₀ would |
| | | the query Q is cached at | return a null response, |
| | | DSM_{i,j} and refreshed at | the query Q is cached at |
| | | rate r until a non-null | DSM_{i,j} and refreshed at |
| | | response is available or | rate r until a non-null |
| | | until time tₙ is reached. | response is available or |
| | | Globally end query Q | until time tₙ is reached. |
| | | after the first response | DSMs that are |
| | | | disconnected within time |
| | | | window [t₀:tₙ] are ignored |
| | | | Globally end query Q |
| | | | after the first response |
| | Single | Shows accumulated | Shows accumulated |
| | Response | results from all DSM_{i,j} to | results from all DSM_{i,j} that |
| | per DSM | respond within time | are connected and |
| | | window [t₀:tₙ] | respond within time |
| | | If DSᵢ at time t₀ would | window [t₀:tₙ] |
| | | return a null response, | If DSᵢ at time t₀ would |
| | | the query Q is cached at | return a null response |
| | | DSM_{i,j} and refreshed at | RS_{i,0}, then |
| | | rate r until a non-null | DSM_{i,j} will initially |
| | | response is available or | respond with a |
| | | until time tₙ is reached. | null response, |
| | | If DSᵢ at time tₚ, where | RS_{i,0}. |
| | | 0 ≦ p ≦ n, has a non-null | DSM_{i,j} will then |
| | | response RS_{i,p}, then | cache the query |
| | | DSM_{i,j} will retrieve RS_{i,p} | Q and refresh it |
| | | and send it back to the | at rate r until a |
| | | QP. | non-null |
| | | Only one response set | response is |
| | | per DSM is allowed; | available or until |
| | | therefore the query Q is | time tₙ is reached. |
| | | flushed from the cache | If DSᵢ at time tₚ, where |
| | | after RS_{i,p} is returned | 0 ≦ p ≦ n, has a non-null |
| | | | response RS_{i,p}, then |
| | | | DSM_{i,j} will retrieve RS_{i,p}. |
| | | | If DSM_{i,j} is |
| | | | connected at time |
| | | | tₚ, then it will send |
| | | | RS_{i,p} back to the |
| | | | QP. |
| | | | If DSM_{i,j} is not |
| | | | connected at time |
| | | | tₚ, then it will |
| | | | cache RS_{i,p}. |
| | | | If DSM_{i,j} |
| | | | reconnects within |
| | | | time window |
| | | | [t₀:tₙ], then it will |
| | | | transmit RS_{i,p} |
| | | | back to the QP |
| | | | Otherwise it will |
| | | | flush RS_{i,p} from |
| | | | the cache after |
| | | | time tₙ. |
| | | | Only one response set |
| | | | per DSM is allowed; |
| | | | therefore the query Q is |
| | | | flushed from the cache |
| | | | after RS_{i,p} is returned |
| | | | DSM_{i,j} that are |
| | | | disconnected throughout |
| | | | time window [t₀:tₙ] are |
| | | | ignored |
| | Multiple | Same as Single Response | Same as Single Response |
| | Responses | Per DSM above, except for: | Per DSM above, except for: |
| | per DSM | The query Q is always | The query Q is always |
| | | cached at DSM_{i,j} and | cached at DSM_{i,j} and |
| | | refreshed at rate r until a | refreshed at rate r until a |
| | | non-null response is | non-null response is |
| | | available or until time tₙ is | available or until time tₙ is |
| | | reached. | reached. |
| | | Multiple response sets | Multiple response sets |
| | | per DSM are allowed; | per DSM are allowed; |
| | | therefore | therefore |
| | | p ∈ [p₁, p₂, . . . , p_{∞}] | p ∈ [p₁, p₂, . . . , p_{∞}] |
| | | The query Q will be | The query Q will be |
| | | flushed from the cache | flushed from the cache |
| | | after time tₙ. | after time tₙ. |
| Unlimited | Single Global | Shows results from the | Shows results from the |
| Time | Response | first DSM_{i,j} to respond | first connected DSM to |
| Window | | within time window [t₀:t_{∞}] | respond within time |
| [t₀:t_{∞}] | | If DSᵢ at time t₀ would | window [t₀:t_{∞}] |
| | | return a null response, | DSMs that are |
| | | the query Q is cached at | disconnected within time |
| | | DSM_{i,j} and refreshed at | window [t₀:t_{∞}] are ignored |
| | | rate r until a non-null | Globally end query Q |
| | | response is available or | after the first response |
| | | until time tₙ is reached. | |
| | | Globally end query Q | |
| | | after the first response | |
| | Single | Shows accumulated | Shows accumulated |
| | Response | results from all DSM_{i,j} to | results from all DSM_{i,j} that |
| | per DSM | respond within time | are connected and |
| | | window [t₀:t_{∞}] | respond within time |
| | | If DSᵢ at time t₀ would | window [t₀:t_{∞}] |
| | | return a null response, | If DSᵢ at time t₀ would |
| | | the query Q is cached at | return a null response |
| | | DSM_{i,j} and refreshed at | RS_{i,0,} then |
| | | rate r | DSM_{i,j} will initially |
| | | If DSᵢ at time tₚ, where | respond with a |
| | | 0 ≦ p ≦ ∞, has a non- | null response, |
| | | null response RS_{i,p}, then | RS_{i,0}. |
| | | DSM_{i,j} will retrieve RS_{i,p} | DSM_{i,j} will then |
| | | and send it back to the | cache the query |
| | | QP. | Q and refresh it |
| | | Only one response set | at rate r |
| | | per DSM is allowed; | If DSᵢ at time t_{p,} |
| | | therefore the query Q is | where 0 ≦ p ≦ ∞, has a |
| | | flushed from the cache | non-null response RS_{i,p}, |
| | | after RS_{i,p} is returned | then DSM_{i,j} will retrieve |
| | | | RS_{i,p}. |
| | | | If DSM_{i,j} is |
| | | | connected at time |
| | | | tₚ, then it will send |
| | | | RS_{i,p} back to the |
| | | | QP. |
| | | | If DSM_{i,j} is not |
| | | | connected at time |
| | | | tₚ, then it will |
| | | | cache RS_{i,p}. |
| | | | If DSM_{i,j} |
| | | | reconnects within |
| | | | time window |
| | | | [t₀:t_{∞}], then it will |
| | | | transmit RS_{i,p} |
| | | | back to the QP |
| | | | Only one response set |
| | | | per DSM is allowed; |
| | | | therefore the query Q is |
| | | | flushed from the cache |
| | | | after RS_{i,p} is returned |
| | | | DSM_{i,j} that are |
| | | | disconnected throughout |
| | | | time window [t₀:t_{∞}]are |
| | | | ignored |
| | Multiple | Same as Single Response | Same as Single Response |
| | Responses | Per DSM above, except for: | Per DSM above, except for: |
| | | The query Q is always | The query Q is always |
| | | cached at DSM_{i,j} and | cached at DSM_{i,j} and |
| | | refreshed at rate r | refreshed at rate r |
| | | Multiple response sets | Multiple response sets |
| | | per DSM are allowed; | per DSM are allowed; |
| | | therefore | therefore |
| | | p ∈ [p₁, p₂, . . . , p_{∞}] | p ∈ [p₁, p₂, . . . , p_{∞}] |
| | | The query Q is never | The query Q is never |
| | | flushed from the cache | flushed from the cache |
| | | unless the user | unless the user |
| | | specifically deletes the | specifically deletes the |
| | | query Q. | query Q. |

IV. Dynamic Query Router Perspective

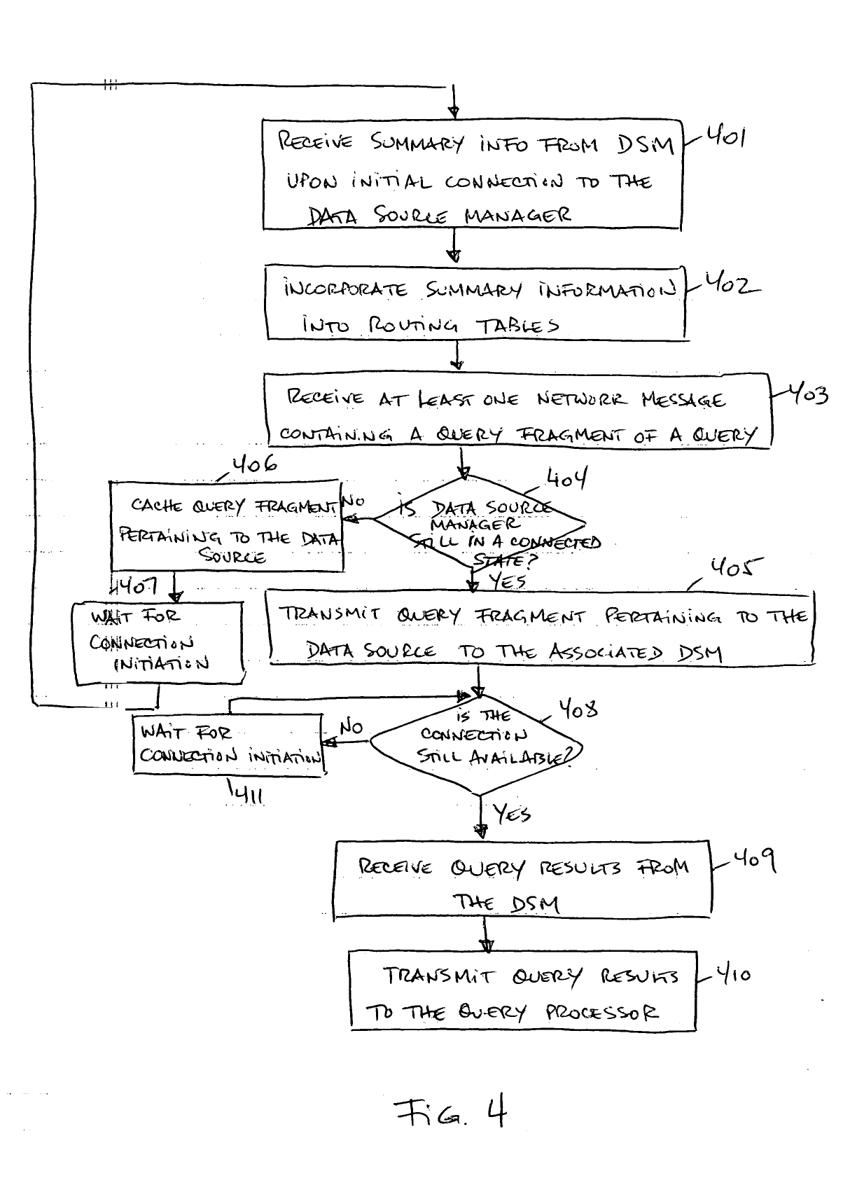

FIG. 4 is a flow diagram illustrating a method for facilitating asynchronous disconnected operations for data access over a network from the perspective of a dynamic query router within the system, according to one embodiment of the invention. As illustrated in FIG. 4, at processing block 401, upon an initial connection with the data source manager 113 and its respective data source 130, summary information containing data stored at the data source 130 is received from the DSM 113.

At processing block 402, the summary information is incorporated into one or more network databases or routing tables to create or to update a distributed data index. In one embodiment, the DQR 114 integrates the summary information related to the data source 130 into one or more network databases or routing tables and updates the distributed index stored therein. The DQR 114 stores the information related to the individual data sources 130 in a hard state, or, alternatively, for a long period of time, to allow a data source manager 113 in a disconnected state to reconnect and to send periodic updates of its summary information via the corresponding DSM 113. In addition, it allows queries or query fragments that are being routed toward such disconnected data sources 130 to access and use the information stored in the routing tables to reach appropriate leaf routers within the network 101. A leaf router is defined to be a DQR 114 that has one or more associated DSMs 113.

At processing block 403, one or more network messages are received, each network message containing a query fragment of a query. In one embodiment, the originating DQR 114 receives the network messages from the QP 111. The DQR 114 will then determine how best to route the query fragment to the set of relevant destinations. It will determine this by consulting its routing table and/or network database. It will discover the set of relevant destinations and calculate the best path to each of those destinations based on some predetermined criteria, such as shortest path. It will then determine the set of neighbor routers that are on the calculated path to these relevant destinations and it will forward a copy of the query fragment to this set of neighbor routers. This process will then be repeated at each DQR 114 along the set of paths from the originating DQR 114 to the leaf routers that correspond to the set of relevant destinations.

At processing block 404, a decision is made whether corresponding data sources 130 are currently in a connected state or disconnected state with regards to the DQR 114. In one embodiment, if the relevant data sources 130 are in a connected state, at processing block 405, the query fragments are transmitted to the DSM 113 associated with the data sources 130.

Otherwise, if the relevant data sources are in a disconnected state, at processing block 406, the DQR 114 caches the query fragments pertaining to the data sources 130. In one embodiment, the DQR 114 stores session information related to the network messages received from the QP 111, such as a message ID, a list of downstream neighbor routers/data sources which have received a copy of the network message, and a list of downstream neighbor routers/data sources which have sent a response to the network message. The DQR 114 keeps track of the downstream data sources 130 that are currently in a connected state. For each data source manager 113 that is already in a connected state or reconnects to the network 101, the DQR 114 will forward a copy of the query fragment network message, as described at processing block 405. If one or more of the downstream neighbor data sources 130 is not currently in a connected state, then the DQR 114 will cache the network message until the data sources 130 become connected.

Then, at processing block 407, the DQR 114 waits for the data source connection initiation and processing blocks 401 through 406 are repeated. In one embodiment, caching of the network message terminates if the query is specified to be answered only once and all possible DSMs 113 have transmitted their query results. Alternatively, the caching of the network message terminates if the query is specified to be answered multiple times and the lifetime of the query expires. Since the query fragment message may be encrypted or compressed, the operational lifetime of the query needs to be specified in the packet header of the network message.

Referring back to FIG. 4, at processing block 408, a decision is made whether the connection to the data sources 130 is still available. If the data sources 130 are still in a connected state, at processing block 409, the originating DQR 114 coupled to the QP 111 receives the query results from the respective DSMs 113 and, at processing block 410, the DQR 114 transmits the query results to the QP 111. Otherwise, if the data sources 130 are in a disconnected state, at processing block 411, the DQR 114 waits for any data source connection initiation and processing block 408 is repeated.

V. Query Processor Perspective

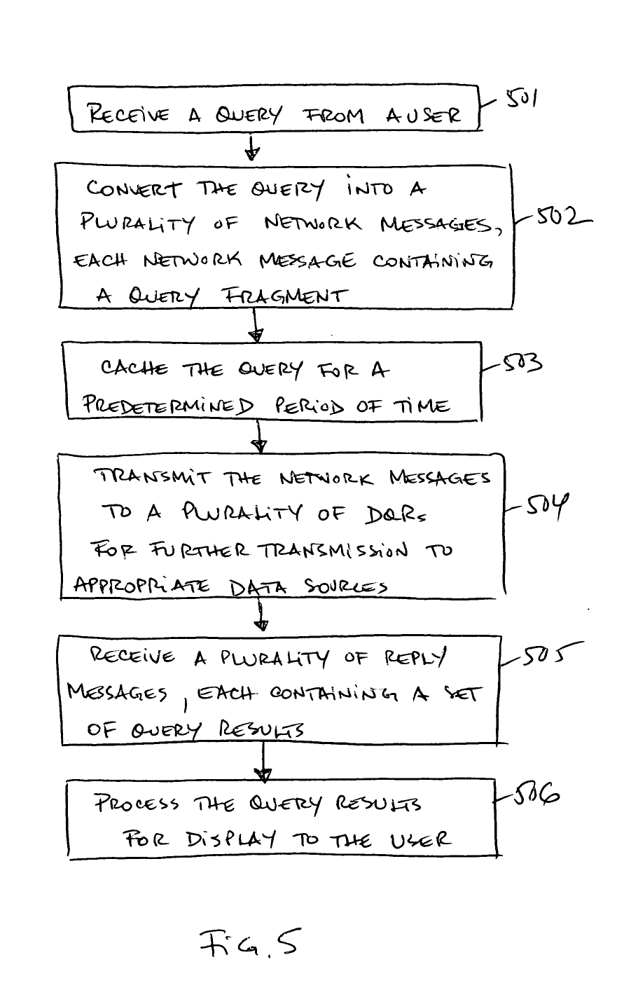

FIG. 5 is a flow diagram illustrating a method for facilitating asynchronous disconnected operations for data access over a network from the perspective of a query processor within the system, according to one embodiment of the invention. As illustrated in FIG. 5, at processing block 501, a query is received from a user. In one embodiment, the QP 111 receives a query formulated by a user via the client systems 120.

At processing block 502, the QP 111 converts the query into a plurality of network messages, each network message containing a query fragment destined for a specific data source 130. At processing block 503, the QP 111 caches the query for a predetermined period of time.

At processing block 504, the QP 111 transmits each network message to its associated DQR 114. This DQR 114 then further transmits the network message in a multi-hop “one-to-many” technique to a plurality of DQRs 114 for further transmission to appropriate data sources 130. At processing block 505, the QP 111 receives a plurality of reply messages, each reply message containing query results from each DQR 114 within the network 101. Finally, at processing block 506, the query results are processed and transmitted to the client systems 120 for further display for the user.

VI. Exemplary Form of a Computer System

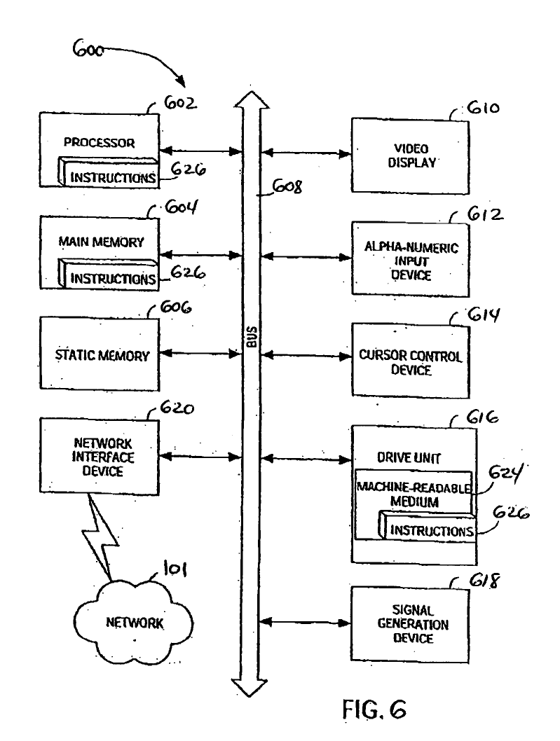

FIG. 6 shows a diagrammatic representation of a machine in the exemplary form of a computer system 600 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 600 includes a processor 602, a main memory 604 and a static memory 606, which communicate with each other via a bus 608. The computer system 600 may further include a video display unit 610, e.g. a liquid crystal display (LCD) or a cathode ray tube (CRT). The computer system 600 also includes an alphanumeric input device 612, e.g, a keyboard, a cursor control device 614, e.g. a mouse, a disk drive unit 616, a signal generation device 618, e.g. a speaker, and a network interface device 620.

The disk drive unit 616 includes a machine-readable medium 624 on which is stored a set of instructions, i.e. software, 626 embodying any one, or all, of the methodologies described above. The software 626 is also shown to reside, completely or at least partially, within the main memory 604 and/or within the processor 602. The software 626 may further be transmitted or received via the network interface device 620.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method comprising the steps of:
receiving at least one query fragment of a query from an associated router within a network;
executing said at least one query fragment against data stored in each data source of a plurality of associated data sources to obtain a set of query results, said each data source storing data related to said at least one query fragment;
determining whether a connection exists to said router within said network; and
transmitting said set of query results to said router if said connection to said router is available.

2. The method according to claim 1, further comprising the step of storing said set of query results until said connection is available.

3. The method according to claim 1, further comprising the steps of:
retrieving data stored within said each data source;
summarizing said data to create item-level data index information associated with said each data source; and
transferring said item-level data index information to said router for further processing.

4. The method according to claim 1, wherein said router is a leaf router of a plurality of routers forming a network of information detailing specific locations of item-level data that runs on top of said network.

5. The method according to claim 1, further comprising the steps of:
storing said at least one query fragment for a predetermined period of time; and
periodically executing said at least one query fragment against said data at user-specified predetermined time intervals.

6. The method according to claim 5, wherein said storing step further comprises the step of storing said at least one query fragment until a storage capacity has been reached.

7. The method according to claim 5, wherein said storing step further comprises the step of storing said at least one query fragment if a network message containing said at least one query fragment contains a flag having a predetermined value.

8. The method according to claim 1, wherein said executing step further comprises the steps of:
translating said at least one query fragment into said each data source's native query interface; and
retrieving said set of query results from said each data source.

9. The method according to claim 1, wherein said query is a Structured Query Language (SQL) query.

10. The method according to claim 1, wherein said network is a wide-area network.

11. The method according to claim 1, wherein said each data source of said plurality of associated data sources is connected via dial-up communication links.

12. The method according to claim 1, wherein said each data source of said plurality of associated data sources is connected via wireless communication links.

13. A method comprising the steps of:
receiving at least one network message from a query processor within a network, said at least one network message containing a query fragment of a query received from a user at said query processor;
determining whether each data source manager of a plurality of disparate data source managers is in a connected state, said each data source manager having at least one associated data source storing data related to said query fragment of said at least one network message; and
storing said query fragment of said at least one network message until said each data source manager reaches said connected state.

14. The method according to claim 13, wherein said receiving step further comprises the steps of:
receiving said at least one network message from an originating router of a plurality of routers forming a network of information detailing specific locations of item-level data that runs on top of said network, said originating router being coupled to said query processor.

15. The method according to claim 13, further comprising the steps of:
maintaining in hard state said connection status of said each data source manager.

16. The method according to claim 13, further comprising the steps of:
receiving item-level data index information from at least one data source manager module coupled to said each data source, upon initial connection of said at least one data source manager module; and
incorporating said item-level data index information into at least one routing table.

17. The method according to claim 16, wherein said at least one data source manager module is connected via dial-up communication links.

18. The method according to claim 16, wherein said at least one data source manager module is connected via wireless communication links.

19. The method according to claim 13, further comprising the steps of:
receiving a set of query results from said each data source manager coupled to said each data source, if said each data source manager is in a connected state; and
transmitting said set of results to said query processor.

20. A method comprising the steps of:
receiving a query in a database language from a user in a network;
converting said query into a plurality of network messages, each network message of said plurality of network messages containing a query fragment of said query;
determining whether each data source manager of a plurality of disparate data source managers is connected to a corresponding router module within said network, said each data source manager having at least one associated data source storing data related to said query fragment of said each network message; and
storing said query for a predetermined period of time until said each data source manager is connected to said corresponding router module within said network.

21. The method according to claim 20, wherein said database language is Structured Query Language (SQL).

22. The method according to claim 20, further comprising the steps of:
transmitting said each network message to an associated router module of a plurality of router modules forming a network of information detailing specific locations of item-level data that runs on top of said network;
receiving a plurality of reply messages from said associated router module, each reply message containing a set of query results; and processing said set of query results of said each reply message for further display for said user.

23. A system comprising:
means for receiving at least one query fragment of a query from an associated router within a network;
means for executing said at least one query fragment against data stored in each data source of a plurality of associated data sources to obtain a set of query results, said each data source storing data related to said at least one query fragment;
means for determining whether a connection exists to said router within said network; and
means for transmitting said set of query results to said router if said connection to said router is available.

24. The system according to claim 23, further comprising means for storing said set of query results until said connection is available.

25. The system according to claim 23, further comprising:
means for retrieving data stored within said each data source;
means for summarizing said data to create item-level data index information associated with said each data source; and
means for transferring said item-level data index information to said router for further processing.

26. The system according to claim 23, wherein said router is a leaf router of a plurality of routers forming a network of information detailing specific locations of item-level data that runs on top of said network.

27. The system according to claim 23, further comprising:
means for storing said at least one query fragment for a predetermined period of time; and
means for periodically executing said at least one query fragment against said data at user-specified predetermined time intervals.

28. The system according to claim 27, further comprising means for storing said at least one query fragment until a storage capacity has been reached.

29. The system according to claim 27, further comprising means for storing said at least one query fragment if a network message containing said at least one query fragment contains a flag having a predetermined value.

30. The system according to claim 23, further comprising:
means for translating said at least one query fragment into said each data source's native query interface; and
means for retrieving said set of query results from said each data source.

31. The system according to claim 23, wherein said query is a Structured Query Language (SQL) query.

32. The system according to claim 23, wherein said network is a wide-area network.

33. The system according to claim 23, wherein said each data source of said plurality of associated data sources is connected via dial-up communication links.

34. The system according to claim 23, wherein said each data source of said plurality of associated data sources is connected via wireless communication links.

35. A system comprising:
means for receiving at least one network message from a query processor within a network, said at least one network message containing a query fragment of a query received from a user at said query processor;
means for determining whether each data source manager of a plurality of disparate data source managers is in a connected state, said each data source manager having at least one associated data source storing data related to said query fragment of said at least one network message; and
means for storing said query fragment of said at least one network message until said each data source manager reaches said connected state.

36. The system according to claim 35, further comprising:
means for receiving said at least one network message from an originating router of a plurality of routers forming a network of information detailing specific locations of item-level data that runs on top of said network, said originating router being coupled to said query processor.

37. The system according to claim 35, further comprising:
means for maintaining in hard state said connection status of said each data source manager.

38. The system according to claim 35, further comprising:
means for receiving item-level data index information from at least one data source manager module coupled to said each data source, upon initial connection of said at least one data source manager module; and
means for incorporating said item-level data index information into at least one routing table.

39. The system according to claim 38, wherein said at least one data source manager module is connected via dial-up communication links.

40. The system according to claim 38, wherein said at least one data source manager module is connected via wireless communication links.

41. The system according to claim 35, further comprising:
means for receiving a set of query results from said each data source manager coupled to said each data source, if said each data source manager is in a connected state; and
means for transmitting said set of results to said query processor.

42. A system comprising:
means for receiving a query in a database language from a user in a network;
means for converting said query into a plurality of network messages, each network message of said plurality of network messages containing a query fragment of said query;
means for determining whether each data source manager of a plurality of disparate data source managers is connected to a corresponding router module within said network, said each data source manager having at least one associated data source storing data related to said query fragment of said each network message; and
means for storing said query for a predetermined period of time until said each data source manager is connected to said corresponding router module within said network.

43. The system according to claim 42, wherein said database language is Structured Query Language (SQL).

44. The system according to claim 42, further comprising:
means for transmitting said each network message to an associated router module of a plurality of router modules forming a network of information detailing specific locations of item-level data that runs on top of said network;
means for receiving a plurality of reply messages from said associated router module, each reply message containing a set of query results; and
means for processing said set of query results of said each reply message for further display for said user.

45. A computer readable medium containing executable instructions, which, when executed in a processing system, cause said processing system to perform a method comprising the steps of:
receiving at least one query fragment of a query from an associated router within a network;
executing said at least one query fragment against data stored in each data source of a plurality of associated data sources to obtain a set of query results, said each data source storing data related to said at least one query fragment;
determining whether a connection exists to said router within said network; and
transmitting said set of query results to said router if said connection to said router is available.

46. The computer readable medium according to claim 45, wherein said method further comprises the step of storing said set of query results until said connection is available.

47. The computer readable medium according to claim 45, wherein said method further comprises the steps of:
retrieving data stored within said each data source;
summarizing said data to create item-level data index information associated with said each data source; and
transferring said item-level data index information to said router for further processing.

48. The computer readable medium according to claim 45, wherein said router is a leaf router of a plurality of routers forming a network of information detailing specific locations of item-level data that runs on top of said network.

49. The computer readable medium according to claim 45, wherein said method further comprises the steps of:
storing said at least one query fragment for a predetermined period of time; and
periodically executing said at least one query fragment against said data at user-specified predetermined time intervals.

50. The computer readable medium according to claim 49, wherein said storing step further comprises the step of storing said at least one query fragment until a storage capacity has been reached.

51. The computer readable medium according to claim 49, wherein said storing step further comprises the step of storing said at least one query fragment if a network message containing said at least one query fragment contains a flag having a predetermined value.

52. The computer readable medium according to claim 45, wherein said executing step further comprises the steps of:
translating said at least one query fragment into said each data source's native query interface; and
retrieving said set of query results from said each data source.

53. The computer readable medium according to claim 45, wherein said query is a Structured Query Language (SQL) query.

54. The computer readable medium according to claim 45, wherein said network is a wide-area network.

55. The computer readable medium according to claim 45, wherein said each data source of said plurality of associated data sources is connected via dial-up communication links.

56. The computer readable medium according to claim 45, wherein said each data source of said plurality of associated data sources is connected via wireless communication links.

57. A computer readable medium containing executable instructions, which, when executed in a processing system, cause said processing system to perform a method comprising the steps of:
receiving at least one network message from a query processor within a network, said at least one network message containing a query fragment of a query received from a user at said query processor;
determining whether each data source manager of a plurality of disparate data source managers is in a connected state, said each data source manager having at least one associated data source storing data related to said query fragment of said at least one network message; and
storing said query fragment of said at least one network message until said each data source manager reaches said connected state.

58. The computer readable medium according to claim 57, wherein said receiving step further comprises the steps of:
receiving said at least one network message from an originating router of a plurality of routers forming a network of information detailing specific locations of item-level data that runs on top of said network, said originating router being coupled to said query processor.

59. The computer readable medium according to claim 57, wherein said method further comprises the steps of:
maintaining in hard state said connection status of said each data source manager.

60. The computer readable medium according to claim 57, wherein said method further comprises the steps of:
receiving item-level data index information from at least one data source manager module coupled to said each data source, upon initial connection of said at least one data source manager module; and
incorporating said item-level data index information into at least one routing table.

61. The computer readable medium according to claim 60, wherein said at least one data source manager module is connected via dial-up communication links.

62. The computer readable medium according to claim 60, wherein said at least one data source manager module is connected via wireless communication links.

63. The computer readable medium according to claim 57, wherein said method further comprises the steps of:
receiving a set of query results from said each data source manager coupled to said each data source, if said each data source manager is in a connected state; and
transmitting said set of results to said query processor.

64. A computer readable medium containing executable instructions, which, when executed in a processing system, cause said processing system to perform a method comprising the steps of:
receiving a query in a database language from a user in a network;
converting said query into a plurality of network messages, each network message of said plurality of network messages containing a query fragment of said query;
determining whether each data source manager of a plurality of disparate data source managers is connected to a corresponding router module within said network, said each data source manager having at least one associated data source storing data related to said query fragment of said each network message; and
storing said query for a predetermined period of time until said each data source manager is connected to said corresponding router module within said network.

65. The computer readable medium according to claim 64, wherein said database language is Structured Query Language (SQL).

66. The computer readable medium according to claim 64, wherein said method further comprises the steps of:
transmitting said each network message to an associated router module of a plurality of router modules forming a network of information detailing specific locations of item-level data that runs on top of said network;
receiving a plurality of reply messages from said associated router module, each reply message containing a set of query results; and
processing said set of query results of said each reply message for further display for said user.

67. A system comprising:
a plurality of routers; and
at least one data source manager module coupled to an associated router of said plurality of routers via communication links within a network;
said at least one data source manager module to receive at least one query fragment of a query from said associated router, to execute said at least one query fragment against data stored in each data source of a plurality of associated data sources to obtain a set of query results, said each data source storing data related to said at least one query fragment, to determine whether a connection to said router exists, and to transmit said set of query results to said router if said connection to said router is available.

68. The system according to claim 67, wherein said at least one data source manager module further stores said set of query results until said connection is available.

69. The system according to claim 67, wherein said at least one data source manager module further retrieves data stored within said each data source, summarizes said data to create item-level data index information associated with said each data source, and transfers said item-level data index information to said router for further processing.

70. The system according to claim 67, wherein said plurality of routers form a network of information detailing specific locations of item-level data that runs on top of said network.

71. The system according to claim 67, wherein said at least one data source manager module further stores said at least one query fragment for a predetermined period of time, and periodically executes said at least one query fragment against said data at user-specified predetermined time intervals.

72. The system according to claim 71, wherein said at least one data source manager module further stores said at least one query fragment until a storage capacity has been reached.

73. The system according to claim 71, wherein said at least one data source manager module further stores said at least one query fragment if a network message containing said at least one query fragment contains a flag having a predetermined value.

74. The system according to claim 67, wherein said at least one data source manager module further translates said at least one query fragment into said each data source's native query interface, and retrieves said set of query results from said each data source.

75. The system according to claim 67, wherein said query is a Structured Query Language (SQL) query.

76. The system according to claim 67, wherein said network is a wide-area network.

77. The system according to claim 67, wherein said each data source of said plurality of associated data sources is connected via dial-up communication links.

78. The system according to claim 67, wherein said each data source of said plurality of associated data sources is connected via wireless communication links.

79. The system according to claim 67, wherein said associated router further receives at least one network message from a query processor within said network, said at least one network message containing said at least one query fragment, determines whether said at least one data source manager module is in said connected state, and stores said at least one query fragment until said at least one data source manager module reaches said connected state.

80. The system according to claim 79, wherein said associated router further receives said at least one network message from an originating router coupled to said query processor.

81. The system according to claim 67, wherein said associated router maintains in hard state said connection status of said at least one data source manager module.

82. The system according to claim 69, wherein said associated router further receives said item-level data index information from said at least one data source manager module upon initial connection of said at least one data source manager module, and incorporates said item-level data index information into at least one routing table.

83. The system according to claim 67, wherein said at least one data source manager module is connected to said associated router via dial-up communication links.

84. The system according to claim 67, wherein said at least one data source manager module is connected to said associated router via wireless communication links.

85. The system according to claim 67, wherein said associated router further receives said set of query results from said at least one data source manager module, and transmits said set of results to said query processor.

86. The system according to claim 79, wherein said query processor further receives said query in a database language from a user, converts said query into said at least one network message, and stores said query for a predetermined period of time.

87. The system according to claim 79, wherein said query processor further receives a plurality of reply messages from said associated router, each reply message containing a set of query results; and processes said set of query results of said each reply message for further display for said user.
